(19) United States
(12) Patent Application Publication
(10) Pub. No.: US 2023/0363502 A1
(43) Pub. Date: Nov. 16, 2023

(54) MULTIFUNCTIONAL SAFETY UMBRELLA

(71) Applicant: Shenzhen Hongjie Umbrella Co., LTD, Guangdong (CN)

(72) Inventor: Lei ZHAO, Guangdong (CN)

(73) Assignee: Shenzhen Hongjie Umbrella Co., LTD, Guangdong (CN)

(21) Appl. No.: 18/317,931

(22) Filed: May 16, 2023

(30) Foreign Application Priority Data
May 16, 2022 (CN) 202221164139.6

(51) Int. Cl. A45B 3/00; B25D 1/00; A62B 3/00

(52) U.S. Cl. CPC A45B 3/00; B25D 1/00; A62B 3/005; A45B 2200/1009

(57) ABSTRACT

This disclosure provides a multi-functional safety umbrella comprising a main pipe. An umbrella tail is fixedly disposed on an upper side of the main pipe, and a safety structure is disposed on a lower side of the main pipe. The safety structure comprises a safety hammer, and an umbrella head is disposed on an outside of the safety structure. The umbrella head is detachably connected with the safety structure. When the umbrella head and the safety structure is fixed together, the safety hammer of the safety structure is hidden in the umbrella head. A safety hammer structure is disposed at a lower position of the main pipe, and then the umbrella head is disposed on the outside of the safety hammer, so that without affecting the overall appearance and use of the umbrella, the safety hammer can be hidden.

### CROSS-REFERENCE TO RELATED APPLICATION

This application claims the priority benefit of China application serial no. 202221164139.6, filed on May 16, 2022. The entirety of the above-mentioned patent application is hereby incorporated by reference herein and made a part of this specification.

### BACKGROUND

### Technical Field

The present application relates to the field of umbrella, in particular to a multifunctional safety umbrella.

### Description of Related Art

Umbrella is a commonly used tool in life, mainly for shading sunlight and rain. An umbrella generally has a canopy and some ribs for supporting the canopy. Umbrella ribs are supported by the main pipe; therefore, the main pipe generally has a certain strength. In daily life, in order to avoid being unable to find an umbrella in case of a sudden rainfall, users generally carry an umbrella with them or place it in their car.

When using the car, some unexpected situations may occur. At this time, it is necessary to break a glass of the car using a safety hammer to escape. Therefore, more and more car owners will equip their cars with a safety hammer. However, for the general user, there are more and more items in the car, which is not conducive to the cleanliness of the car.

### SUMMARY

Based on this, it is necessary to provide a multifunctional umbrella against the problems in the prior art.

A multifunctional safety umbrella, comprising a main pipe, an umbrella tail being fixedly disposed on an upper side of the main pipe, a safety structure being disposed on a lower side of the main pipe, the safety structure comprising a safety hammer, an umbrella head being disposed on an outside of the safety structure, the umbrella head being detachably connected with the safety structure, when the umbrella head and the safety structure being fixed together, the safety hammer of the safety structure being hidden in the umbrella head.

In one of the embodiments, the umbrella head is provided with a recess, and when the umbrella head is fixed with the safety structure, the safety hammer is located in the recess of the umbrella head.

In one of the embodiments, the safety structure comprises a fixing body, the fixing body is provided with a fixing groove, the lower side of the main pipe is inserted into the fixing groove and fixed with the fixing body, and the safety hammer is located on a lower side of the fixing body.

In one of the embodiments, the fixing body is provided with a plurality of fixing pin holes, pins are disposed in the fixing pin holes, and the fixing body and the main pipe are fixed by pins.

In one of the embodiments, a recessed hole is disposed at a bottom of the fixing body, and the safety hammer is fixed in the recessed hole.

In one of the embodiments, an outer end of the safety hammer is a cone, and a sharp portion with a certain taper is formed at the outer end of the safety hammer.

In one of the embodiments, another cone with the same angle of the taper of the shar portion is disposed at the lower side of the fixing body.

In one of the embodiments, two snap structures are symmetrically disposed on two sides of an upper side of the fixing body, each of the snap structures comprises a snap body, a snap portion and a pressing portion are disposed on an upper side of the snap body, a lower side of the snap body is fixedly connected with the fixing body, the snap body and the snap portion are tilted outward, and when the pressing portion is pressed by an external force, the snap portion moves towards the fixing body.

In one of the embodiments, a snap recess corresponding to the snap portion of each of the snap structures is disposed inside the recess of the umbrella head, and when the umbrella head is snapped and fixed with the fixing body by the two snap structures, the snap portion snaps into the snap recess.

According to the above multi-functional safety umbrella, a safety hammer structure is disposed at a lower position of the main pipe, and then the umbrella head is disposed on the outside of the safety hammer, so that without affecting the overall appearance and use of the umbrella, the safety hammer can be hidden. When the safety hammer is needed, it is necessary to only remove the umbrella head. After use, the umbrella head can be installed again without affecting the normal use of the umbrella.

### BRIEF DESCRIPTION OF THE DRAWINGS

FIG. 1 is a schematic diagram of the multifunctional umbrella according to the present disclosure.

FIG. 2 is a schematic diagram of the umbrella head of the multifunctional umbrella according to the present disclosure.

FIG. 3 is a schematic diagram of the safety structure of the multifunctional umbrella according to the present disclosure.

### DESCRIPTION OF THE EMBODIMENTS

In order to make the above purpose, features and advantages of the present disclosure more obvious and easier to understand, the specific embodiments of the present disclosure will be described in detail in the following in conjunction with the accompanying drawings. In the following description, many specific details are elaborated in order to fully understand the present disclosure. However, the present disclosure may be implemented in many other ways different from those described herein, and those skilled in the art may make similar improvements without violating the content of the present disclosure, so the present disclosure is not limited by the specific embodiments disclosed below.

It should be noted that when a component is said to be “fixed” to another component, it can be directly on top of another component or other components can exist in between. When a component is considered to be “connected” to another component, it can be directly connected to another component or other components can exist in between at the same time. Conversely, when a component is described as “directly on” another component, there is no intermediate component. The terms “vertical”, “horizontal”, “left”, “right” and similar expressions used herein are for illustrative purposes only.

Unless otherwise defined, all technical and scientific terms used herein have the same meaning as those normally understood by those skilled in the technical art of the present disclosure. The terms used in the specification of the present disclosure herein are only for the purpose of describing specific embodiments, and are not intended to limit the present disclosure. As used herein, the terms “and/or” include any and all combinations of one or more related items listed.

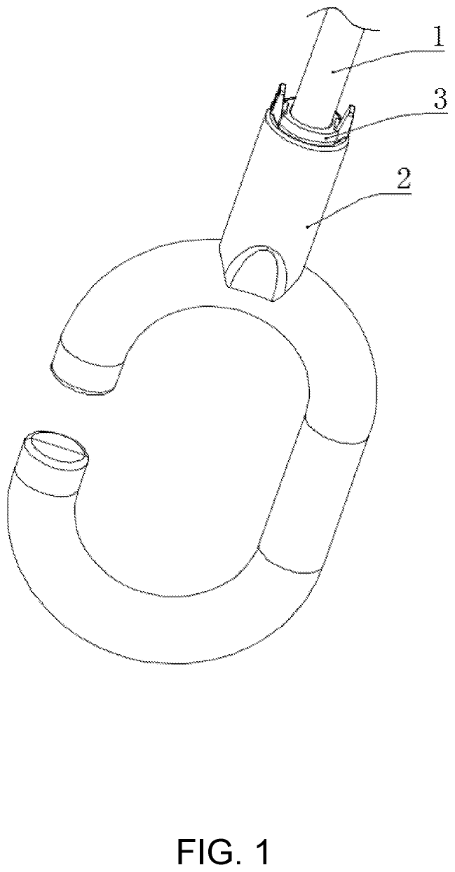

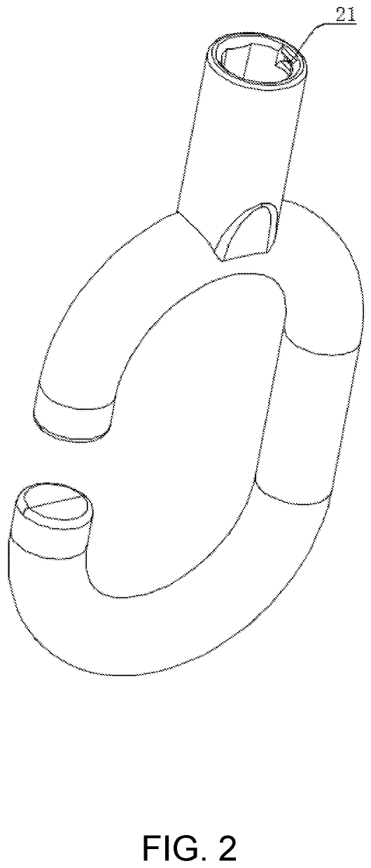

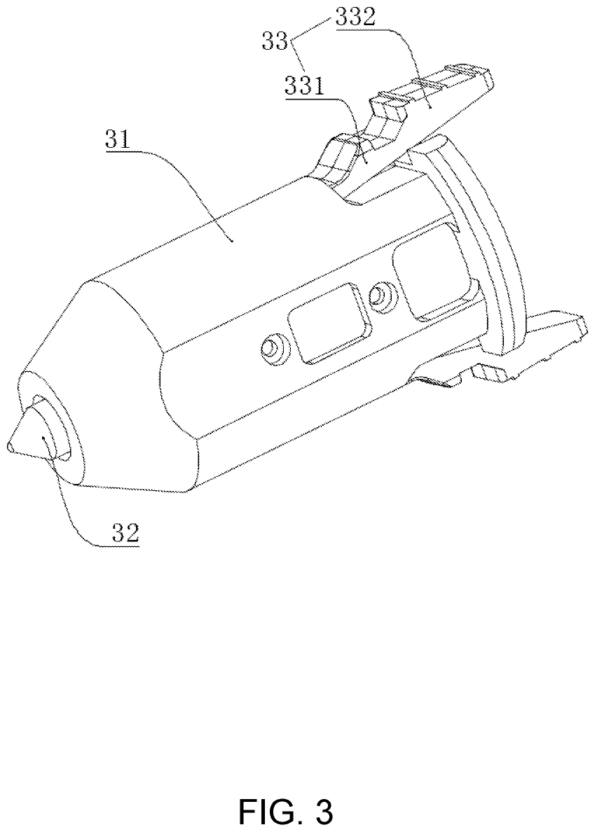

As shown in FIG. 1 to FIG. 3, a multifunctional safety umbrella comprises a main pipe 1. An umbrella tail is fixedly disposed on the upper side of the main pipe 1, and a safety structure 3 is disposed on the lower side of the main pipe 1. The safety structure 3 comprises a safety hammer 32, and an umbrella head 2 is disposed on the outside of the safety structure 3. The umbrella head 2 is detachably connected with the safety structure 3. When the umbrella head 2 and the safety structure 3 are fixed together, the safety hammer 32 of the safety structure 3 is hidden in the umbrella head 2.

A safety hammer 32 is disposed at a lower position of the main pipe 1, and then the umbrella head 2 is disposed on the outside of the safety hammer 32, so that without affecting the overall appearance and use of the umbrella, the safety hammer 32 can be hidden. When the safety hammer 32 is needed, it is necessary to only remove the umbrella head 2. After use, the umbrella head 2 can be installed again without affecting the normal use of the umbrella.

Here, in this embodiment, in order to hide the safety hammer, the umbrella head 2 is provided with a recess, and when the umbrella head 2 is fixed with the safety structure 3, the safety hammer 32 is located in the recess of the umbrella head 2. That is, under normal use, the safety hammer 32 of the umbrella is hidden in the recess of the umbrella head 2. If the umbrella head 2 is not removed, the safety hammer 32 will not be exposed, and the normal use of the safety hammer 32 will not be affected.

The safety hammer 32 is fixedly connected with the main pipe 1 through the safety structure 3. Because the safety hammer 32 will be subject to a large impact during use, the safety hammer 32 needs to be fixed firmly. In this embodiment, the safety structure 3 comprises a fixing body 31, the fixing body 31 is provided with a fixing groove. The lower side of the main pipe 1 is inserted into the fixing groove and fixed with the fixing body 31, and the safety hammer 32 is located on a lower side of the fixing body 31. Further, the fixing body 31 is provided with a plurality of fixing pin holes. Pins are disposed in the fixing pin holes, and the fixing body 31 and the main pipe 1 are fixed by pins. The main pipe 1 is inserted into the fixing groove, and then the main pipe 1 and the fixing body 31 are fixed together by pins, so that the fixing body 31 of the safety structure 3 can be fixed with the main pipe 1. And at the same time, since the main pipe 1 is disposed in the fixing groove of the fixed body 31, when the safety hammer 32 on the lower side of the fixed body 31 is impacted, the main pipe 1 and the fixing body 31 can provide better support for the safety hammer 32, and the fixing body 31 is not easily damaged.

For the connection between the fixing body 31 and the safety hammer 32, in this embodiment, a recessed hole is disposed at a bottom of the fixing body, and the safety hammer is fixed in the recessed hole. The safety hammer 32 is disposed at the bottom of the fixing body 31, and by providing a recessed hole, the safety hammer 32 can be better fixed.

During use, in order to increase the efficiency of the safety hammer 32 breaking a window, an outer end of the safety hammer 32 is a cone, and a sharp portion with a certain taper is formed at the outer end of the safety hammer 32. By the sharp portion formed, during use, the contact point between the safety hammer 32 and the glass is small, so that it is easier to break the glass. At the same time, in order to avoid the safety hammer 32 being affected by the fixed body 31 during use, here, the lower side of the fixing body 31 is provided with a cone with the same angle of the taper of the sharp portion. Therefore, during use, the lower side of the fixing body 31 will not affect the contact between the safety hammer 32 and the glass, and thus will not affect the normal use of the safety hammer 32.

The umbrella head 2 and the safety structure 3 are detachably connected. In this embodiment, two snap structures 33 are symmetrically disposed on both sides of an upper side of the fixing body 31. The snap structure 33 comprises a snap body. A snap portion 331 and a pressing portion 332 are disposed on an upper side of the snap body, and the snap body is fixedly connected with the fixing body 31 on the lower side of the snap body. The snap body and the snap portion 331 are tilted outward, and when the pressing portion 332 is pressed by an external force, the snap portion 331 moves towards the fixing body 31. Further, a snap recess 21 corresponding to the snap portion 331 of the snap structure 33 is disposed inside the recess of the umbrella head 2. When the umbrella head 2 is snapped and fixed with the fixing body 31 by the snap structure 33, the snap portion 331 snaps into the snap recess 21. That is, the umbrella head 2 and the fixing body 31 of the safety structure 3 fixed together by the snap structure 33, which can ensure the normal use of the umbrella. When the safety hammer 32 is needed, by pressing down the pressing portion 332, the snap portion 331 can be moved towards the axis of the fixing body 31, so that the snap portion 331 is separated from the snap recess 21, and the umbrella head 2 can be removed to expose the safety hammer 32. Then the main pipe 1 can be held to use the safety hammer 32. At this time, the sharp portion of the safety hammer 32 faces outward, and the window breaking can be performed.

The technical features of the embodiments described above may be arbitrarily combined, and for the sake of conciseness, not all possible combinations of the technical features in the above embodiments are described. However, as long as there is no contradiction in the combination of these technical features, they should be considered to be within the scope of the present description.

The above embodiments only express several embodiments of the present disclosure, and their description is more specific and detailed, but it cannot be understood as a limitation on the scope of the disclosure. It should be noted that for those of ordinary skill in the art, without departing from the principles of the present disclosure, certain modifications and improvements may also be made, and these also fall within the scope of protection of the present disclosure. Therefore, the scope of protection of this disclosure shall be subject to the attached claims.

What is claimed is:

1. A multifunctional safety umbrella, comprising a main pipe, an umbrella tail being fixedly disposed on an upper side of the main pipe, a safety structure being disposed on a lower side of the main pipe, the safety structure comprising a safety hammer, an umbrella head being disposed on an outside of the safety structure, the umbrella head being detachably connected with the safety structure, when the umbrella head and the safety structure being fixed together, the safety hammer of the safety structure being hidden in the umbrella head.

2. The multifunctional safety umbrella according to claim 1, wherein the umbrella head is provided with a recess, and when the umbrella head is fixed with the safety structure, the safety hammer is located in the recess of the umbrella head.

3. The multifunctional safety umbrella according to claim 2, wherein the safety structure comprises a fixing body, the fixing body is provided with a fixing groove, the lower side of the main pipe is inserted into the fixing groove and fixed with the fixing body, and the safety hammer is located on a lower side of the fixing body.

4. The multifunctional safety umbrella according to claim 3, wherein the fixing body is provided with a plurality of fixing pin holes, pins are disposed in the fixing pin holes, and the fixing body and the main pipe are fixed by pins.

5. The multifunctional safety umbrella according to claim 4, wherein a recessed hole is disposed at a bottom of the fixing body, and the safety hammer is fixed in the recessed hole.

6. The multifunctional safety umbrella according to claim 5, wherein an outer end of the safety hammer is a cone, and a sharp portion with a taper is formed at the outer end of the safety hammer.

7. The multifunctional safety umbrella according to claim 6, wherein another cone with a same angle of the taper of the sharp portion is disposed at the lower side of the fixing body.

8. The multifunctional safety umbrella according to claim 6, wherein two snap structures are symmetrically disposed on two sides of an upper side of the fixing body, each of the snap structures comprises a snap body, a snap portion and a pressing portion are disposed on an upper side of the snap body, a lower side of the snap body is fixedly connected with the fixing body, the snap body and the snap portion are tilted outwards, and when the pressing portion is pressed by an external force, the snap portion moves towards the fixing body.

9. The multifunctional safety umbrella according to claim 8, wherein a snap recess corresponding to the snap portion of each of the snap structures is disposed inside the recess of the umbrella head, and when the umbrella head is snapped and fixed with the fixing body by the two snap structures, the snap portion snaps into the snap recess.
